(19) United States
(12) Patent Application Publication
(10) Pub. No.: US 2004/0207595 A1
(43) Pub. Date: Oct. 21, 2004

(54) Light module and flat panel display including the light module

(75) Inventor: Ying-Chieh Chen, Nantou (TW)

Correspondence Address: QUINTERO LAW OFFICE, 1617 BROADWAY, 3RD FLOOR, SANTA MONICA, CA, 90404, US

(73) Assignee: Toppoly Optoelectronics Corp.

(21) Appl. No.: 10/417,530

(22) Filed: Apr. 17, 2003

(51) Int. Cl. G09G 3/36

(52) U.S. Cl. 345/102

(57) ABSTRACT

A light module and a flat panel display including the light module. The light module includes a light guiding plate having four sides; three light guide sticks disposed on the three sides of the light guiding plate; and two light sources, each being disposed between two adjacent light guide sticks. The light beam emitted from at least one light source can be received by the three light guide sticks and then enters the light guiding plate from the three sides of the light guiding plate. In this way, light is incident from three sides of the light guiding plate, thus enhancing uniform distribution of light.

### BACKGROUND OF THE INVENTION

1. Field of the Invention

The present invention relates to a light module, and more particularly to a light module achieving a high degree of light uniformity.

2. Description of the Prior Art

FIG. 1 is a front view of a conventional light module. The light module includes a light guiding plate (LGP) 100. A light guide pipe (light guide stick) 200 is provided on the top side 110 of the light guiding plate 100. Two light emitting diodes (LEDs) 400 are provided on two sides of the light guide stick 200. The light guide stick 200 has an outer surface 200a for reflecting light. The outer surface 200a is in the form of a saw shape and referred to as “V-cut”. In addition, a reflector sheet 300 is provided on the outer surface 200a, also for reflecting light.

The light emitted from LEDs 400 first enters the light guide stick 200, then is reflected by the V-cut 200a and the reflector sheet 300, then enters the light guiding plate 100 from the top side 110. Since light enters the light guiding plate 100 from only one side, uneven light distribution results.

### SUMMARY OF THE INVENTION

An object of the present invention is to solve the above-mentioned problem and provide a light module capable of achieving a high degree of light uniformity, while maintaining use of two light sources. Light is incident to the light guiding plate from three sides.

To achieve the above objects, the light module of the present invention includes a light guiding plate having four sides; three light guide sticks disposed on the three sides of the light guiding plate; and two light sources, wherein each light source has an emitting surface and is disposed between two adjacent light guide sticks. The light beam emitted from at least one light source can be received by the three light guide sticks and then enters the light guiding plate from the three sides of the light guiding plate.

The present invention also provides a flat panel display including a light guiding plate having four sides; three light guide sticks disposed on the three sides of the light guiding plate; two light sources, wherein each light source has an emitting surface and is disposed between two adjacent light guide sticks; an optical sheet disposed on a surface of the light guiding plate; and a display panel disposed on the optical sheet. The light beam emitted from at least one light source can be received by the three light guide sticks and then enters the light guiding plate from the three sides of the light guiding plate.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a front view of a conventional light module.

FIG. 2 is a front view of a light module according to a first preferred embodiment of the present invention.

FIG. 3 is a front view of a light module according to a second preferred embodiment of the present invention.

FIG. 4 is a perspective view of a second reflector sheet in a light module according to a third preferred embodiment of the present invention.

FIG. 5 shows a cross-section of a flat panel display of the present invention.

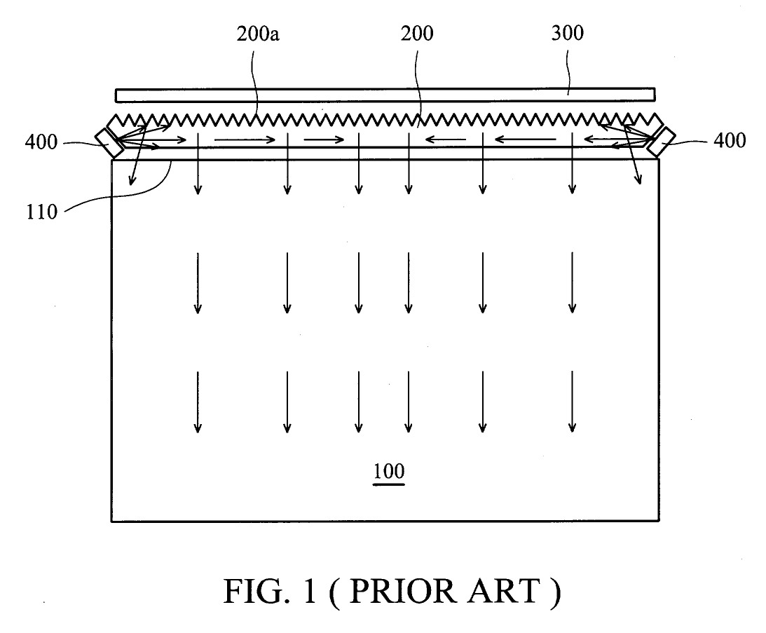

### DETAILED DESCRIPTION OF THE INVENTION

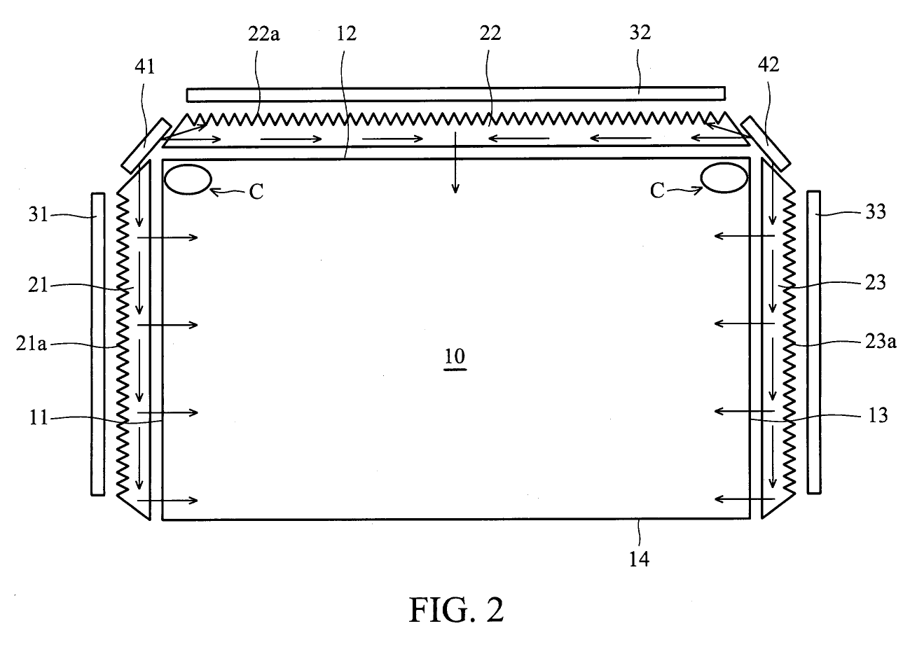

FIG. 2 is a front view of a light module according to a first preferred embodiment of the present invention. The light module includes a light guiding plate 10, three light guide sticks 21, 22, and 23, and two light sources 41 and 42.

The light guiding plate 10 has four sides: left side 11, top side 12, right side 13, and bottom side 14. Three light guide sticks 21, 22, and 23 are disposed on the left side 11, top side 12, and right side 13 of the light guide plate 10 respectively. The light source suitable for use in the present invention can be a light emitting diode (LED). The light source 41 is disposed between the light guide sticks 21 and 22, and the light source 42 is disposed between the light guide sticks 22 and 23. In this way, three light guide sticks 21, 22, and 23 can receive a light beam emitted from at least one light source. Specifically, the light guide stick 21 can receive the light beam emitted from the light source 41, the light guide stick 22 can receive the light beam emitted from the light sources 41 and 42, and the light guide stick 23 can receive the light beam emitted from the light source 42. Thus, after entering the light guide sticks 21, 22, and 23, light can then enter the light guiding plate 10 from the three sides (left side 11, top side 12, and right side 13) of the light guiding plate 10.

Outer surfaces 21a, 22a, and 23aof the light guide sticks 21, 22, and 23 respectively can be in the form of a saw shape, referred to as “V-cut”, for reflecting light. Moreover, the light module of the present invention can further include three first reflector sheets 31, 32, and 33 disposed on outer surfaces 21a, 22a, and 23aof the three light guide sticks 21, 22, and 23 respectively for light reflection.

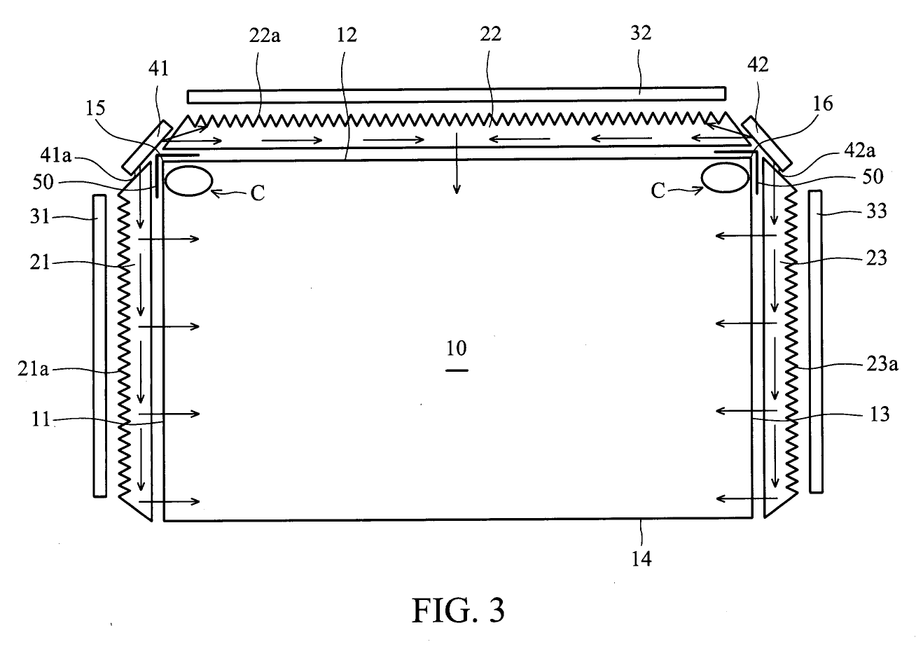

Referring to FIG. 2, portion C in the light guiding plate 10, which is adjacent to the light sources 41 and 42, may be too bright, resulting a bright corner. Referring to FIG. 3, showing a light module according to a second preferred embodiment of the present invention, in order to prevent the bright corner, a second reflector sheet 50 can be disposed at a corner 15 between the emitting surface 41a of the light source 41 and the light guiding plate 10, and another second reflector sheet 50 can be disposed at a corner 16 between the emitting surface 42a of the light source 42 and the light guiding plate 10. The second reflector sheet 50 is used for reflecting light, thus preventing generation of a light corner at portion C in the light guiding plate 10. The second reflector sheet 50 can have an L-shaped cross section.

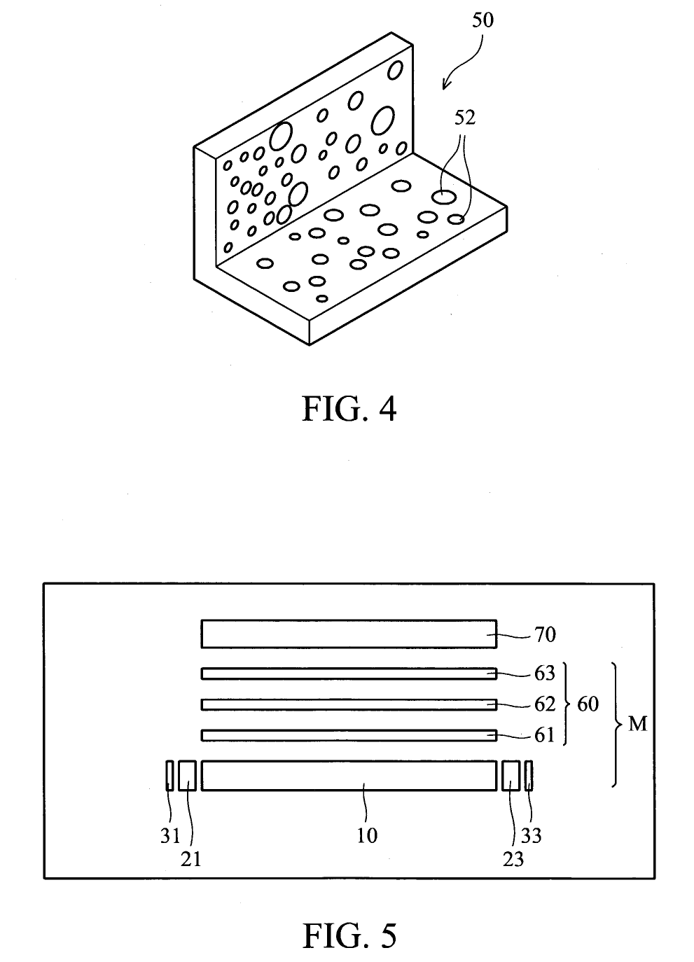

However, disposition of the second reflector sheet 50 may result in generation of a dark corner at portion C. Therefore, referring to FIG. 4, showing a front view of a light module according to a third preferred embodiment of the present invention, a plurality of micropores 52 can be provided on the second reflector sheet 50 for light to pass through. Thus, generation of a dark corner at portion C in the light guiding plate 10 can be prevented.

FIG. 5 is a cross-section of a flat panel display of the present invention. The flat panel display includes a light module M and a display panel 70. The light module M includes the light guiding plate 10, three light guide sticks 21, 22, and 23, two light sources 41 and 42, three first reflectors 31, 32, and 33 as mentioned above in FIG. 3, and an optical sheet 60. The display panel 70 can be a liquid crystal panel.

Generally, the optical sheet 60 can include a diffuser sheet, a prism sheet, or a combination thereof. The diffuser sheet has a light scattering effect for evenly distributing the light emitted from the light source, and the prism sheet focuses the scattered light to a certain degree to enhance the brightness (luminance). For example, in FIG. 5, the optical sheet 60 including one diffuser sheet 61 and two prism sheets 62 and 63 is provided on a surface of the light guiding plate 10.

In conclusion, the present invention disposes three light guide sticks on three sides of the light guiding plate respectively and two light sources between every two adjacent light guide sticks. In this way, light is incident from three sides of the light guiding plate, thus enhancing uniform distribution of light, while maintaining use of two light sources.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A light module, comprising:
a light guiding plate having four sides;
three light guide sticks disposed on the three sides of the light guiding plate; and
two light sources, wherein each light source has an emitting surface and is disposed between two adjacent light guide sticks, such that the light beam emitted from at least one light source can be received by the three light guide sticks and then enters the light guiding plate from the three sides of the light guiding plate.

2. The light module as claimed in claim 1, wherein the light guide stick has a saw-shaped outer surface for reflecting light.

3. The light module as claimed in claim 1, further comprising three first reflector sheets, each first reflector sheet being disposed on an outer surface of each light guide stick for reflecting light.

4. The light module as claimed in claim 1, wherein the light source is a light emitting diode (LED).

5. The light module as claimed in claim 1, further comprising two second reflector sheets, each second reflector sheet being used for reflecting light and being disposed at a corner between the emitting surface of each light source and the light guiding plate.

6. The light module as claimed in claim 5, wherein the second reflector sheet has an L-shaped cross section.

7. The light module as claimed in claim 5, wherein the second reflector sheet has a plurality of micropores for light to pass through.

8. The light module as claimed in claim 1, further comprising an optical sheet disposed on a surface of the light guiding plate.

9. A light module comprising:
a light guiding plate having four sides;
three light guide sticks disposed on the three sides of the light guiding plate, wherein the light guide stick has a saw-shaped outer surface for reflecting light;
two light emitting diodes (LEDs), wherein each LED has an emitting surface and is disposed between two adjacent light guide sticks, such that the light beam emitted from at least one LED can be received by the three light guide sticks and then enters the light guiding plate from the three sides of the light guiding plate;
three first reflector sheets, each first reflector sheet being disposed on an outer surface of each light guide stick for reflecting light; and
an optical sheet disposed on a surface of the light guiding plate.

10. The light module as claimed in claim 9, further comprising two second reflector sheets, each second reflector sheet being used for reflecting light and disposed at a corner between the emitting surface of each LED and the light guiding plate.

11. The light module as claimed in claim 10, wherein the second reflector sheet has an L-shaped cross section.

12. The light module as claimed in claim 10, wherein the second reflector sheet has a plurality of micropores for light to pass through.

13. A flat panel display, comprising:
a light guiding plate having four sides;
three light guide sticks disposed on the three sides of the light guiding plate;
two light sources, wherein each light source has an emitting surface and is disposed between two adjacent light guide sticks, such that the light beam emitted from at least one light source can be received by the three light guide sticks and then enters the light guiding plate from the three sides of the light guiding plate;
an optical sheet disposed on a surface of the light guiding plate; and
a display panel disposed on the optical sheet.

14. The flat panel display as claimed in claim 13, wherein the light guide stick has a saw-shaped outer surface for reflecting light.

15. The flat panel display as claimed in claim 13, further comprising three first reflector sheets, each first reflector sheet being disposed on an outer surface of each light guide stick for reflecting light.

16. The flat panel display as claimed in claim 13, wherein the light source is a light emitting diode (LED).

17. The flat panel display as claimed in claim 13, further comprising two second reflector sheets, each second reflector sheet being used for reflecting light and disposed at a corner between the emitting surface of each light source and the light guiding plate.

18. The flat panel display as claimed in claim 17, wherein the second reflector sheet has an L-shaped cross section.

19. The flat panel display as claimed in claim 17, wherein the second reflector sheet has a plurality of micropores for light to pass through.

20. The flat panel display as claimed in claim 13, wherein the display panel is a liquid crystal display panel.
